(19) United States
(12) Patent Application Publication
(10) Pub. No.: US 2016/0207230 A1
(43) Pub. Date: Jul. 21, 2016

(54) METHOD FOR MANUFACTURING ENDLESS BELT

(71) Applicant: FUJI XEROX CO., LTD., Tokyo (JP)

(72) Inventor: Hiroaki TANAKA, Kanagawa (JP)

(73) Assignee: FUJI XEROX CO., LTD., Tokyo (JP)

(21) Appl. No.: 14/875,823

(22) Filed: Oct. 6, 2015

(30) Foreign Application Priority Data
Jan. 20, 2015 (JP) 2015-008595

(51) Int. Cl. B29C 41/26; B29C 69/00; B29C 41/46; B29C 71/02

(52) U.S. Cl. CPC B29C 41/26; B29C 71/02; B29C 69/001; B29C 41/46; B29K 2079/08

(57) ABSTRACT

Provided is a method for manufacturing an endless belt, including forming a coating film on an outer circumferential surface of a cylindrical or columnar core body such that a film thickness of at least a portion of a non-product portion of an endless belt on a coating starting side of a resin solution is 30% or less of a film thickness of a product portion while the resin solution is discharged with respect to the outer circumferential surface of the core body from a solution discharging unit to coat the outer circumferential surface of the core body, heating and curing the coating film formed on the outer circumferential surface of the core body to obtain an endless belt, separating the endless belt formed in the heating from the core body, and cutting a non-product portion in both end portions of the endless belt separated from the core body.

### CROSS-REFERENCE TO RELATED APPLICATIONS

This application is based on and claims priority under 35 USC 119 from Japanese Patent Application No. 2015-008595 filed Jan. 20, 2015.

### BACKGROUND

(i) Technical Field

The present invention relates to a method for manufacturing an endless belt.

(ii) Related Art

An electrophotographic image forming apparatus forms an electrical charge on a surface of an image holding member which is an electrophotographic photoreceptor formed of an inorganic or organic material, forms an electrostatic latent image by using a laser beam or the like that is obtained by modulating an image signal, and then develops the electrostatic latent image by an electrified toner so as to form a visualized toner image. Subsequently, a reproduction image is obtained by electrostatically transferring the toner image to a transfer material such as a recording sheet directly or via a belt (an intermediate transfer belt) which is an intermediate transfer body.

### SUMMARY

According to an aspect of the invention, there is provided a method for manufacturing an endless belt, including:

forming a coating film on an outer circumferential surface of a cylindrical or columnar core body such that a film thickness of at least a portion of a non-product portion of an endless belt on a coating starting side of a resin solution is 30% or less of a film thickness of a product portion while the resin solution is discharged with respect to the outer circumferential surface of the core body from a solution discharging unit to coat the outer circumferential surface of the core body along a direction from one end portion to the other end portion of the core body, with the core body being rotated in a circumferential direction and an axial direction of the core body being parallel to a horizontal direction;

heating and curing the coating film formed on the outer circumferential surface of the core body to obtain an endless belt;

separating the endless belt formed in the heating from the core body; and

cutting a non-product portion in both end portions of the endless belt separated from the core body.

### BRIEF DESCRIPTION OF THE DRAWINGS

Exemplary embodiments of the present invention will be described in detail based on the following figures, wherein:

FIG. 1 is a schematic diagram illustrating an end portion, on the coating starting side, of an endless belt which is manufactured according to the present exemplary embodiment;

FIG. 2 is a schematic diagram illustrating an example of a flow-coating method;

FIG. 3 is a schematic diagram illustrating an example of a flow-coating method; and

FIG. 4 is a schematic diagram illustrating an example of a heating step.

### DETAILED DESCRIPTION

In the following description, it will be described based on an example of an exemplary embodiment of the present invention with reference to the drawings. Note that in the drawings, for ease of understanding, the illustration of members other than those necessary for illustration is appropriately omitted. Also, the members having the same functions are given the same reference numerals throughout the drawings, and the description thereof will be omitted in some cases.

In the following exemplary embodiment, as an example of an endless belt, an example of a manufacturing method of an intermediate transfer belt in an image forming apparatus will be described; however, use of the endless belt which is manufactured through a method for manufacturing the endless belt according to the exemplary embodiment is not particularly limited. For example, the manufacturing method of the endless belt may be applied to manufacture other types of endless belts such as a fixing belt and a paper transporting belt.

The method for manufacturing the endless belt according to the exemplary embodiment includes a coating step for forming a coating film on an outer circumferential surface of a cylindrical or columnar core body such that a film thickness of at least a portion of a non-product portion of an endless belt on a coating starting side of a resin solution is 30% or less of a film thickness of a product portion, while the resin solution is discharged with respect to the outer circumferential surface of the core body from a solution discharging unit to coat the outer circumferential surface of the core body along a direction from one end portion to the other end portion of the core body, with the core body being rotated in a circumferential direction and an axial direction of the core body being parallel to a horizontal direction; a heating step for heating and curing the coating film which is formed on the outer circumferential surface of the core body so as to obtain an endless belt; a separating step for separating the endless belt which is formed in the heating step from the core body; and cutting step for cutting a non-product portion in both end portions of the endless belt which is separated from the core body.

For example, when manufacturing an endless belt in such a manner that the resin solution flows down on the outer circumferential surface of the core body through a spiral coating method (a flow-coating method) so as to form a coating film and then heat and cure the coating film, as a method for manufacturing an intermediate transfer belt of an image forming apparatus, a defect (a blister defect) in which the film of one end portion of the coating starting side is blistered occurs, and thus the film formability is deteriorated in some cases. As a cause of the blister defect, it is considered that a size of an initial liquid droplet becomes larger due to surface tension at the time of starting the coating, a film is thickened in the vicinity of the start of the film deposition, due to the thickening of the film at the end portion, a gas which is generated when a solvent in the film is volatilized during drying is not easily discharged from the vicinity of the end portion, and bubbles are accumulated on an interface between the film and the core body and thus the film is lifted from the core body. With this, the blister defect occurs. In a case where such a blister at the end portion of the coating film occurs in a product portion (an image forming portion), the precut is not available.

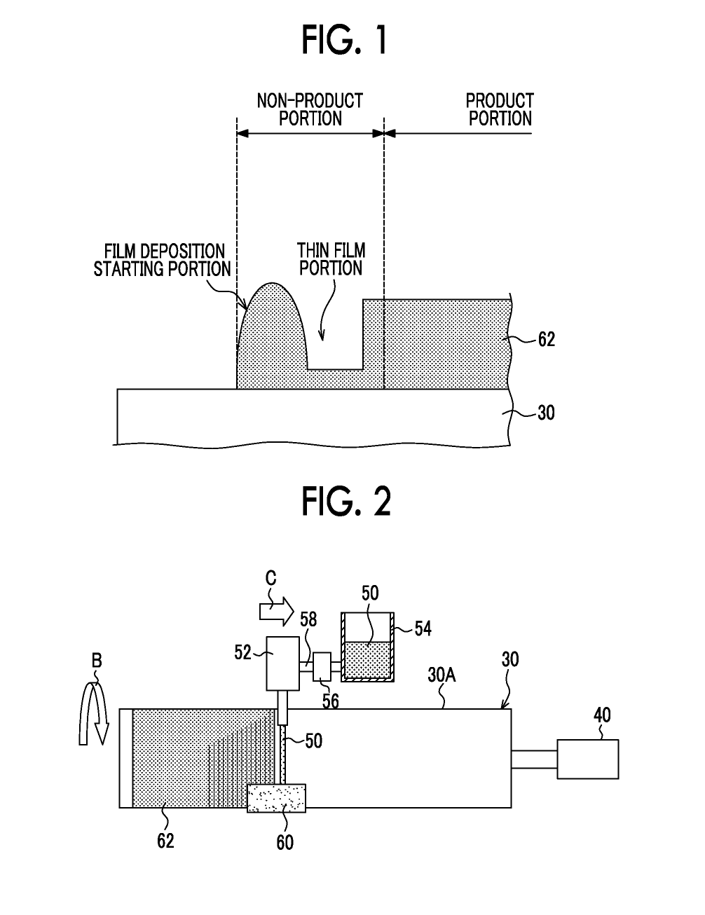

In contrast, in the exemplary embodiment, the coating film is formed such that the film thickness of at least a portion of the end portion which corresponds to the non-product portion on the coating starting side of the endless belt is 30% or less of the film thickness of the product portion. FIG. 1 schematically illustrates the end portion on the coating starting side (film deposition starting side) of the endless belt manufactured according to the exemplary embodiment. As illustrated in FIG. 1, with respect to an outer circumferential surface of a core body 30, a coating film 62 is formed to include a thin film portion in which the film thickness of the end portion which corresponds to the non-product portion on the coating starting side of the endless belt is 30% or less of the film thickness of the product portion (hereinafter, on the coating starting side of the resin solution, a portion in which the film thickness of the non-product portion of the endless belt is 30% or less of the film thickness of the product portion is simply referred to as the “thin film portion” in some cases). With such a configuration, the gas generated in the vicinity of the end portion before curing is easily discharged from the side surface of the thin film portion, and thus it is possible to suppress the occurrence of the blister defect, and to improve the film formability so as to increase a yield rate.

Coating Step

In the coating step, while a resin solution is discharged with respect to an outer circumferential surface of the cylindrical or columnar core body from a solution discharging unit to coat the outer circumferential surface of the core body along a direction from one end portion to the other end portion of the core body with the core body being rotated in a circumferential direction and an axial direction of the core body being parallel to a horizontal direction, a coating film is formed on the outer circumferential surface of the core body such that the film thickness of at least a portion of the non-product portion of an endless belt on the coating starting side of the resin solution is 30% or less of the film thickness of the product portion.

Here, “an axial direction of the core body being parallel to a horizontal direction” does not mean a case where the axial direction of the core body is completely horizontal. For example, the axial direction of the core body may be inclined several degrees with respect to the horizontal direction as long as the resin solution which is discharged with respect to the outer circumferential surface of the core body from the solution discharging unit is prevented from being unevenly moved to one side of the axial direction of the core body.

Resin Solution

The resin solution which is used in the exemplary embodiment includes a resin or a precursor thereof, a solvent, or the like.

As the resin which forms the intermediate transfer belt, for example, a polyimide resin (hereinafter, referred to as a PI in some cases) and a polyamideimide resin (hereinafter, referred to as a PAI in some cases) are used in terms of the strength and dimensional stability, heat resistance, or the like. However, examples of the resin are not limited thereto. As the PI or the PAI, various known materials may be used, and in a case of the PI, the precursor thereof may be used to be coated.

A PI precursor solution which is the resin solution is obtained by reacting a tetracarboxylic dianhydride and a diamine component with each other in a solvent, for example. Although types of the respective components are not particularly limited, it is preferable that the PI precursor solution is obtained by reacting an aromatic tetracarboxylic dianhydride and an aromatic diamine component with each other in terms of the film strength.

Representative examples of the aromatic tetracarboxylic dianhydride include a pyromellitic dianhydride, a 3,3′,4,4′-biphenyltetracarboxylic acid dianhydride, a 3,3′,4,4′-benzophenonetetracarboxylic acid dianhydride, a 2,3,4,4′-biphenyltetracarboxylic acid dianhydride, a 2,3,6,7-naphthalenetetracarboxylic acid dianhydride, a 1,2,5,6-naphthalenetetracarboxylic acid dianhydride, and a 2,2-bis(3,4-dicarboxy phenyl)ether dianhydride, or tetracarboxylic acid ester thereof, or a mixture of the tetracarboxylic acids.

On the other hand, examples of the aromatic diamine component include paraphenylenediamine, methaphenylenediamine, 4,4′-diaminodiphenyl ether, 4,4′-diaminophenylmethane, benzidine, 3,3′-dimethoxybenzidine, 4,4′-diaminodiphenyl propane, 2,2-bis[4-(4-aminophenoxy)phenyl]propane, and the like.

On the other hand, the PAI is obtained by composing an acid anhydride such as a trimellitic acid anhydride, ethylene glycol bisanhydrotrimellitate, propylene glycol bisanhydrotrimellitate, a pyromellitic anhydride, a benzophenone tetracarboxylic acid anhydride, and a 3,3′,4,4′-biphenyltetracarboxylic acid anhydride, and the above-described diamine, and performing polycondensation reaction in an equimolar amount. The PAI includes an amide group, and thus is easily dissolved in the solvent even when the imidation reaction progresses, therefore, it is preferable to employ a 100% of imidized material.

Examples of the solvent which is included in the resin solution include an aprotic polar solvent such as N-methylpyrrolidone, N,N-dimethylacetamide, and acetamide.

The concentration and viscosity of the resin solution are not limited, but a desired solid concentration and the viscosity of the solution in the exemplary embodiment are respectively from 10 weight % to 40 weight %, and from 1 Pa·s to 100 Pa·s.

Conductive particles may be added to the resin solution if necessary. Examples of the conductive particles which are dispersed in the resin solution include a carbon-based material such as carbon black, carbon fibers, carbon nanotubes, and graphite, metal or an alloy such as copper, silver, and aluminum, conductive metal oxides such as tin oxide, indium oxide, and antimony oxide, whisker such as potassium titanate, and the like. Among these, in terms of dispersion stability in the solution, conductive development properties, or a cost, the carbon black is particularly preferable.

As a method for dispersing the conductive particles, it is possible to employ known methods which are performed by using a ball mill, a sand mill (a bead mill), a jet mill (against collision type dispersing machine), or the like. A surfactant and a leveling agent may be added as a dispersion assistant. The dispersion concentration of the conductive particles is preferably from 10 parts to 40 parts, and particularly from 15 parts to 35 parts with respect to 100 parts of the resin component (part by weight, the same hereinafter).

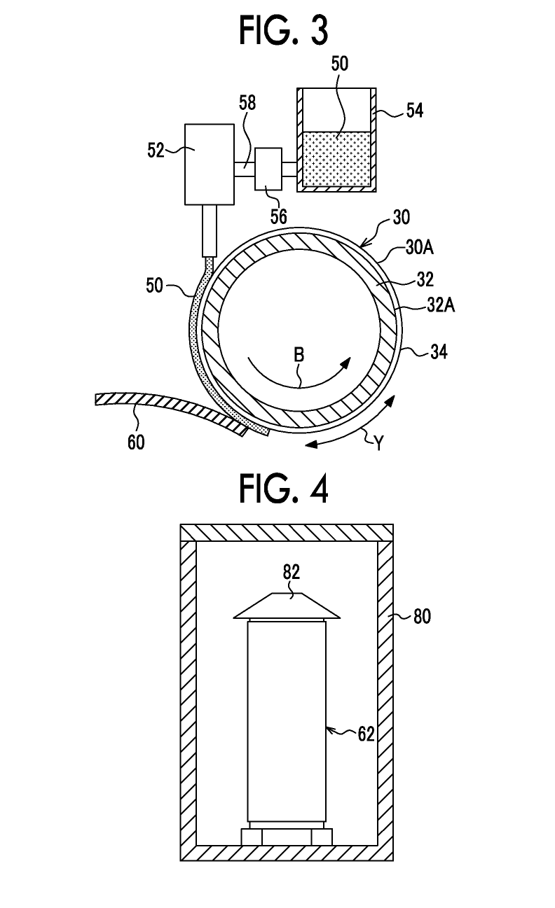

In the exemplary embodiment, a spiral coating method (a flow-coating method) is used as a coating method of the resin solution. FIG. 2 and FIG. 3 are schematic diagrams illustrating an example of the flow-coating method.

In the flow-coating method, as illustrated in FIG. 2 and FIG. 3, a resin solution 50 is discharged from a solution ejecting device 52 which is a solution discharging unit so as to be coated on an outer circumferential surface 30A of the core body 30 while rotating a cylindrical or columnar core body 30 around an axis (direction of arrow B), by a rotating device 40, by assuming an axial direction of the core body to be a horizontal direction. The resin solution 50 is supplied to the solution ejecting device 52 from a tank 54 storing the resin solution 50 through a supply pipe 58 by using a pump 56. The resin solution 50 which is attached on the outer circumferential surface 30A of the core body 30 is smoothed by a spatula 60.

As illustrated in FIG. 3, the core body 30 is provided with a cylindrical or columnar core main body 32 in which an endless belt is manufactured by heating and curing the coating film 62 of the resin solution coated to the outer circumferential surface 30A, and a release layer 34 which is formed on an outer circumferential surface 32A including the center portion in the axial direction of the core main body 32. Note that, in FIG. 3, a circumferential direction of the core main body 32 (the core body 30) is indicated by an arrow Y.

Examples of materials of the core main body 32 which are used in the exemplary embodiment include metal such as aluminum and stainless steel. The width (the length of the axial direction) of the core main body 32 (the core body 30) is necessary to exceed the width (the length of the axial direction) of a target endless belt, but in order to secure a spare area with respect to a non-product portion (an invalid area) in the end portion, it is desirable that the width of the core main body 32 is larger than the width of the target intermediate transfer belt in a range from 10% to 40%. The circumferential length (the length in the circumferential direction) of the core main body 32 (the core body 30) is set to be the same as or slightly longer than that of the intermediate transfer belt, for example.

The release layer 34 is formed by covering, for example, a material selected from an inorganic compound, a silicone resin, a fluorine resin on the outer circumferential surface 32A of the core main body 32. The covering of the material on the outer circumferential surface 32A of the core main body 32 is performed by, for example, heating and baking the core main body 32 after coating a mold release agent by the above material on the outer circumferential surface 32A of the core main body 32. In addition, the release layer 34 is formed by, for example, performing plating treatment of chromium, nickel, or the like with respect to the outer circumferential surface 32A of the core main body 32.

The solution ejecting device 52 and the spatula 60 are movably supported in the axial direction (direction of arrow C) of the core body 30, and in a state where the core body 30 is rotated at a rotation speed which is set in advance, when the resin solution 50 is discharged while moving the solution ejecting device 52 and the spatula 60 in the axial direction (direction of arrow C) of the core body 30, the resin solution 50 is spirally coated on the surface of the core body 30, and then a spiral muscle is smoothed by the spatula 60 to be extinguished, thereby forming an endless coating film 62.

As described above, when the resin solution 50 is discharged with respect to the outer circumferential surface of the core body 30 from the solution ejecting device 52, and is coated on the outer circumferential surface 30A of the core body 30 from one end portion to the other end portion of the core body 30, the coating film 62 is formed on the outer circumferential surface of the core body 30 in such a manner that the film thickness of at least a portion (the thin film portion) of the non-product portion of the endless belt on the coating starting side of the resin solution 50 is 30% or less of the film thickness of the product portion. The coating film 62, thereafter, becomes an endless belt by being further cured in the heating step, via the drying step if necessary. In the exemplary embodiment, the coating film 62 is formed on the coating step such that the film thickness of at least a portion of the non-product portion of the finally obtained endless belt is 30% or less of the film thickness of the product portion; however, the thickness of the endless belt obtained after the heating step is generally proportional to the thickness of the coating film 62, and thus the coating film 62 may be formed on the outer circumferential surface 30A of the core body 30 such that the thickness of at least a portion of the coating film of a part corresponding to the non-product portion is 30% or less of the thickness of the coating film corresponding to the product portion.

Meanwhile, in the non-product portion of the endless belt on the coating starting side of the resin solution 50, the gas in a product portion is easily discharged as the thin film portion is close to the product portion, and the gas which is formed by the volatilization of the solvent is easily discharged as the width of the thin film portion of the coating film becomes larger; however, if the width of the thin film portion is excessively large, the film thickness of the product portion is highly likely to be affected thereby. The film thickness of the entire non-product portion on the coating starting side of resin solution 50 is not necessarily to be 30% or less of the film thickness of the product portion, and when the thin film portion which is 30% or less of the film thickness of the product portion is formed in a portion of the non-product portion, the gas is easily discharged from the periphery of the thin film portion, thereby suppressing the blister defect.

The width of the thin film portion on the coating starting side is not particularly limited, but when the width of the thin film portion is excessively large, it causes an increase in a material cost and manufacturing time, and the width of the thin film portion is excessively small, the gas is not easily discharged. Considering this, in general, it is desired that the thin film portion having the width from 20 mm to 60 mm is formed in an area from 50 mm to 100 mm from a tip end of the coating film on the coating starting side.

In addition, in terms of suppressing occurrence of the blister at the end portion on the coating starting side, it is preferable that the coating film 62 is formed on the outer circumferential surface of the core body 30 such that the film thickness of at least a portion of (the thin film portion) of the non-product portion of the endless belt on the coating starting side of the resin solution is 21% or less of the film thickness of the product portion.

A method of forming the thin film portion at the end portion on the coating starting side is not particularly limited. Examples of method of forming the thin film portion include a method of reducing an amount of the solution discharged from the solution ejecting device 52, a method of raising a rotation speed of the core body 30, a method of raising a moving speed of the solution ejecting device 52 with respect to the axial direction of the core body 30, and a method of reducing a gap between the core body 30 and the spatula 60. In terms of the easiness for adjusting the film thickness and the film formability, it is preferable to employ a method of adjusting the amount of the resin solution discharged from the solution ejecting device 52.

Note that, the film thickness of the product portion of the endless belt which is formed after the heating step is set, for example, in a range from 50 μm to 150 μm, as necessary.

Drying Step

After the coating step, the coating film is heated and cured, however, before curing the coating film, the drying step for drying the coating film may be performed. Here, “drying” means a “heating” for vaporizing a predetermined amount or more of the solvents included in the resin solution (a thermosetting solution) which forms the coating film 62.

Specifically, it is preferable that the core body 30 is heated and dried while being rotated by the rotating device 40. Heating conditions are set such that a temperature is preferably from 80° C. to 200° C. for from 10 minutes to 60 minutes, and the higher the temperature, the shorter the heating time and the drying time. In the heating, it is also effective to apply the hot air. The heating may be performed by raising the temperature stepwise or at a certain speed. During the heating, in order to suppress a sag in the coating film, the core body 30 may be slowly rotated in a range from 5 rpm to 60 rpm.

Heating Step

In the heating step, the endless belt is formed by heating and curing the coating film 62 which is formed on the outer circumferential surface of the core body 30.

The heating step is necessary when using a material which causes curing reaction on the resin solution by heating the PI precursor or the like. In the heating step, for example, as illustrated in FIG. 4, the core body in which the coating film 62 is formed on the outer circumferential surface is input and heated in a heating furnace 80. The heating temperature is preferably from 250° C. to 450° C., more preferably from 300° C. to 350° C., and the imidation reaction is caused by heating (baking) the coating film 62 of the PI precursor solution for 20 minutes to 60 minutes, and a PI resin film (the endless belt) is formed. In the heating reaction, it is preferable that the heating is performed by raising the temperature stepwise or gradually at a certain speed before reaching a final temperature of the heating.

Meanwhile, in such a high temperature, a roll which is provided in the rotating device does not have heat resistance, and thus in the heating step, the core body may be detached from the rotating device so as to be input to the heating furnace 80. In general, the core body is input to the heating furnace 80 in a state where the axial direction of the core body is parallel to the gravity direction, that is, the core body is perpendicularly erected. The heating furnace 80 is preferably configured to blow the hot air to the above the core body 30, which is perpendicularly erected, so as to eliminate as much as possible the internal temperature irregularity. In addition, in order to prevent the hot air from directly blowing to an upper portion of the core body, as illustrated in FIG. 4, a shielding member 82 which shields the upper portion of the core body from the air may be installed. The shape of the shielding member 82 is not particularly limited as long as an end of the core body may be covered.

Separating Step

In the separating step, the endless belt which is formed in the heating step is separated from the core body 30.

In the separating step, for example, after the heating step, the core body is extracted from the heating furnace 80 so as to be cooled at room temperature, then the air is injected to a gap between the endless belt and the end portion in the axial direction of the outer circumferential surface 30A of the core body, thereby separating the endless belt from the core body.

Cutting Step

In the cutting step, the non-product portions in both end portions of the endless belt which is separated from the core body 30 are cut out. With this, the endless belt which is formed only in the product portion, that is, the intermediate transfer belt is obtained.

Note that, the intermediate transfer belt may be subjected to a hole punching process, a rib attaching process, and the like, if necessary.

The intermediate transfer belt which is obtained by the method for manufacturing the endless belt according to the exemplary embodiment is a transfer body which transfers an image transferred from a photosensitive body or the like, to a recording medium, and is used to an image forming apparatus such as an electrophotographic copy machine and a laser printer.

As described above, the method for manufacturing the endless belt according to the exemplary embodiment is described, but the exemplary embodiment is not limited to the above described exemplary embodiment described in FIG. 1 to FIG. 4.

For example, in the exemplary embodiment, a case of manufacturing the endless belt having a one-layer structure is described, but the exemplary embodiment may be applied to the manufacturing of the endless belt having a two-layer structure or a lamination structure having three or more layers may be applied to the endless belt. In addition, in the manufacturing of the endless belt which has a lamination structure having two or more layers and includes a drying step for each layer, when applying the method of manufacturing the endless belt according to exemplary embodiment to at least one layer of the coating film, it is possible to suppress the blister defect in the applied coating film, and to increase the manufacturing yield of the endless belt.

In addition, in a case where the resin solution is the PAI solution, a film is formed by curing the PAI solution through the drying step for drying the solvent. In this case, the drying step corresponds to the heating step in the exemplary embodiment.

### EXAMPLES

Hereinafter, Examples will be described, but the invention is not limited to Examples in the following description.

### Example 1

Preparation of Core Body

As the core main body, a mold having an inner diameter of 909.5 mm, an outer diameter of 929.5 mm, and the length of a body portion of 1,000 mm is used. In addition, a material which is formed by diluting a silicone-based mold release agent (Sepacoat, manufactured by Shin-Etsu Chemical Co., Ltd.) with n-heptane at 1:15 (weight ratio) is coated on the outer circumferential surface of the core main body, and baked at 420° C. for 40 minutes, thereby forming a release layer.

Forming First Coating Film

The polyimide precursor solution is formed by adding the same varnish having high viscosity (brand name: U-VARNISH manufactured by UBE INDUSTRIES, LTD., viscosity: 140 Pa·s, solid concentration: 18 weight %, and the solvent is N-methyl pyrrolidone) to polyimide varnish (brand name: U-VARNISH manufactured by UBE INDUSTRIES, LTD., viscosity: 5 Pa·s, solid concentration: 18 weight %, and the solvent is N-methyl pyrrolidone) in which carbon particles (Special Black 4 manufactured by Degussa) are dispersed, and the viscosity is adjusted to be 12 Pa·s.

Next, the both end portions are installed so as to come in contact with the driving roll such that the axial direction of the core body becomes horizontal, and then, in a state of rotating the core body in a circumferential direction at 51.3 rpm, the polyimide precursor solution which is imparted to the core body surface is smoothed by using the spatula while causing the polyimide precursor solution to flow down from the solution ejecting device to the core body surface (the outer circumferential surface) which is being rotated, a flow-down point of the polyimide precursor solution and the spatula are moved from one end to the other end of the core body center portion in the horizontal direction (the axial direction of the core body), and thus the first coating film is formed on the core body surface. Note that, at this time, an amount of the flow-down of the polyimide precursor solution (the discharge amount from the solution ejecting device) is set as 20.4 g/20 sec, and the moving speed of the flow-point and the spatula in the horizontal direction is set as 51.3 mm/s, a forming area (the width in the axial direction) of the first coating film in the center portion of the core body is set as 905 mm.

First Drying Step

The both end portions are installed in a dry furnace so as to come in contact with the driving roll such that the axial direction of the core body becomes horizontal, and then, the core body in which the first coating film is formed on the outer circumferential surface is dried at 187° C. for 26 minutes while being rotated at 20 rpm.

Forming Second Coating Film

The both end portions are installed so as to come in contact with the driving roll such that the axial direction of the core body is horizontal, and then, in a state of rotating the core body, on which the first coating film is formed, at 51.3 rpm, the polyimide precursor solution which is imparted to the core body surface is smoothed by using the spatula while causing a liquid (viscosity: 75 Pa·s), which is different from the liquid used to form the first coating film as the polyimide precursor solution, to flow down to the core body surface which is being rotated, the flow-down point of the polyimide precursor solution and the spatula are moved from one end to the other end of the core body center portion in the horizontal direction (the axial direction of the core body), and thus the second coating film is formed on the core body surface. Note that, at this time, the amount of the flow-down of the polyimide precursor solution is set as 3 g/20 sec until the length of coating after the coating starts reaches 20 mm, thereafter as 20.4 g/20 sec, and the moving speed of the flow-point and the spatula in the horizontal direction is set as 51.3 mm/s, a forming area (the width in the axial direction) of the second coating film in the center portion of the core body is set as 837 mm.

Second Drying Step

The both end portions are installed in the dry furnace so as to come in contact with the driving roll such that the axial direction becomes horizontal, and then, the core body in which the second coating film is formed is dried at 187° C. for 26 minutes while being rotated at 20 rpm.

Baking Step (Heating Step)

Subsequently, the core body after the drying treatment is installed in the heating furnace such that the axial direction of the core body becomes a vertical direction, and is baked. In addition, the baking is performed by gradually raising the temperature so as to become 315° C. from the vicinity of room temperature after 2 hours in the heating furnace, and holding the temperature at 315° C. for 40 minutes.

With this, the endless belt which is obtained by laminating the first layer by the first coating film and the second layer by the second coating film is formed on the outer circumferential surface of the core body, and the endless belt is extracted from the core body.

### Example 2

The forming of the first coating film and the first drying are performed in the same way as in Example 1.

The forming of the second coating film is performed in the same way as in Example 1 except that the amount of the flow-down of the polyimide precursor solution at the time of coating is set as 5 g/20 sec until the length of coating after the coating starts reaches 20 mm, and thereafter as 20.4 g/20 sec.

Thereafter, the second drying and the baking step are also performed under the same condition as in Example 1.

### Example 3

The forming of the first coating film and the first drying are performed as in Example 1.

The forming of the second coating film is performed in the same way as in Example 1 except that the amount of the flow-down of the polyimide precursor solution at the time of coating is set as 7.2 g/20 sec until the length of coating after the coating starts reaches 20 mm, and thereafter as 20.4 g/20 sec.

Thereafter, the second drying and the baking step are also performed under the same condition as in Example 1.

### Comparative Example 1

The forming of the first coating film and the first drying are performed as in Example 1.

The forming of the second coating film is performed in the same way as in Example 1 except that the amount of the flow-down of the polyimide precursor solution at the time of coating is set as 11.3 g/20 sec until the length of coating after the coating starts reaches 20 mm, and thereafter as 20.4 g/20 sec.

Thereafter, the second drying and the baking step are also performed under the same condition as in Example 1.

Measurement of Film Thickness

Regarding the endless belt which is manufactured in the respective Example, the film thickness of a position (corresponding to the non-product portion) which is away from the tip end by 5 mm on the coating starting side of the second layer and the film thickness of a position (corresponding to the product portion) which is away from the tip end by 100 mm on the coating starting side of the second layer are respectively measured by using a film thickness gauge (ID-CA) manufactured by Mitsutoyo Corp., and the difference of film thickness between the first layer and the second layer is set as the film thickness of the second layer. Note that, the film thickness of the first layer is calculated from the amount of flow-down from the fact that the amount of flow-down is proportional to the film thickness since there is not the baking step from after forming the first coating film to form the second coating film. In addition, the film thickness of the second layer at each position is set as an average value by being measured at equally spaced four positions in the circumferential direction.

Rate of Occurrence of Blister Defect

In the respective Examples and Comparative Example, ten endless belts are manufactured under the same conditions, and the rate of occurrence of the blister defect is calculated by confirming the existence of the blister defect on the coating starting side.

The film thickness of the second layer of the endless belt which is manufactured in each of Examples and Comparative Example and an evaluation result are indicated in Table 1.

TABLE 1

| | Film | | | | |
|---|---|---|---|---|---|
| | thickness of | | | | |
| | second layer | | | | |
| | (μm) | | Difference | | |
| | Non- | | in film | Ratio in | Rate of |
| | product | Product | thickness | film | occurrence |
| | portion | portion | (μm) | thickness | of blister |
| | (A) | (B) | (B − A) | (%) (A/B) | defect (%) |
| Example 1 | 11.25 | 67 | 55.75 | 16.8 | 0 |
| Example 2 | 14 | 67 | 53 | 20.9 | 0 |
| Example 3 | 20 | 67 | 47 | 29.9 | 10 |
| Comparative | 24 | 67 | 43 | 35.9 | 80 |
| Example 1 | | | | | |

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A method for manufacturing an endless belt, comprising:
forming a coating film on an outer circumferential surface of a cylindrical or columnar core body such that a film thickness of at least a portion of a non-product portion of an endless belt on a coating starting side of a resin solution is 30% or less of a film thickness of a product portion while the resin solution is discharged with respect to the outer circumferential surface of the core body from a solution discharging unit to coat the outer circumferential surface of the core body along a direction from one end portion to the other end portion of the core body, with the core body being rotated in a circumferential direction and an axial direction of the core body being parallel to a horizontal direction;
heating and curing the coating film formed on the outer circumferential surface of the core body to obtain an endless belt;
separating the endless belt formed in the heating from the core body; and
cutting a non-product portion in both end portions of the endless belt separated from the core body.

2. The method for manufacturing an endless belt according to claim 1,
wherein in the coating, an amount of the resin solution discharged from the solution discharging unit is adjusted such that the film thickness of at least a portion of the non-product portion of the endless belt on the coating starting side of the resin solution is 30% or less of the film thickness of the product portion.

3. The method for manufacturing an endless belt according to claim 1,
wherein a film thickness of the product portion of the endless belt formed after the heating is in a range from 50 μm to 150 μm.
